(19) United States
(12) Patent Application Publication
(10) Pub. No.: US 2026/0134125 A1
(43) Pub. Date: May 14, 2026

(54) COMMUNICATION ACQUISITION SYSTEM

(71) Applicant: CENTER MOBILE CO., LTD., Osaka-shi, Osaka (JP)

(72) Inventor: Tatsuya NAKAGOSHI, Osaka (JP)

(21) Appl. No.: 18/866,896

(22) PCT Filed: May 12, 2023
(86) PCT No.: PCT/JP2023/017947

§ 371 Date: Jul. 16, 2025

(30) Foreign Application Priority Data
May 19, 2022 (JP) 2022-082357

(51) Int. Cl. G06F 21/62; H04W 24/08

(52) U.S. Cl. CPC G06F 21/6218; H04W 24/08

(57) ABSTRACT

A communication log acquisition system includes: a contractor information storage part that stores line identification information and consent information in a state associated with each other, the line identification information assigned to a contractor of a communication service, the consent information indicating that the contractor of the communication service has consented to acquisition of confidentiality of communication of a communication terminal to which the line identification information is set; and a communication log acquisition part that acquires a communication log from a communication path that is connected to a communication line used by a communication terminal to which the line identification information associated with the consent information is set.

### CROSS-REFERENCE TO RELATED APPLICATIONS

This application claims priority from Japanese Patent Application No. 2022-082357, the entire disclosure of which is incorporated herein by reference.

### FIELD

The present invention relates to a communication log acquisition system that acquires a communication log on a communication network.

### BACKGROUND

Conventionally, as disclosed in, for example, Patent Literature 1, it is known that an action history, which is a communication log of a device that performs communication based on a SIM card, is acquired by an action history management server and this action history is used for various purposes.

However, the above-mentioned conventional system includes so-called confidentiality of communication (e.g., call records, email addresses, number of SMS sent, connection history for data communication, charge history for data usage, data usage information, information unobtainable without the consent of the person), and there is a problem in that even action history that should be protected are uniformly acquired by the action history management server.

### CITATION LIST

### Patent Literature

Patent Literature 1: JP 2019-133247 A

### SUMMARY

### Technical Problem

In view of the above circumstances, an object of the present invention is to provide a communication log acquisition system that can appropriately acquire a communication log including confidentiality of communication.

### Solution to Problem

A communication log acquisition system of the present invention includes:
a contractor information storage part that stores line identification information and consent information in a state associated with each other, the line identification information assigned to a contractor of a communication service, the consent information indicating that the contractor of the communication service has consented to acquisition of confidentiality of communication of a communication terminal to which the line identification information is set; and
a communication log acquisition part that acquires a communication log from a communication path that is connected to a communication line used by a communication terminal to which the line identification information associated with the consent information is set.

### BRIEF DESCRIPTION OF DRAWINGS

FIG. 1 is a schematic diagram of a use environment of a communication log acquisition system according to an embodiment of the present invention.

FIG. 2 is a block diagram of a contract system to be used in conjunction with the communication log acquisition system according to the embodiment.

FIG. 3 is a block diagram of the communication log acquisition system according to the embodiment.

FIG. 4 is a flowchart for explaining a flow of a contract for a communication service performed before using the communication log acquisition system according to the embodiment.

FIG. 5 is a sub-flowchart for explaining a flow of a communication service performed before acquiring a communication log in the communication log acquisition system according to the embodiment.

FIG. 6 is a flowchart for explaining a flow of operations of the communication log acquisition system according to the embodiment.

### DESCRIPTION OF EMBODIMENTS

Hereinafter, a communication log acquisition system according to one embodiment of the present invention will be described with reference to the accompanying drawings.

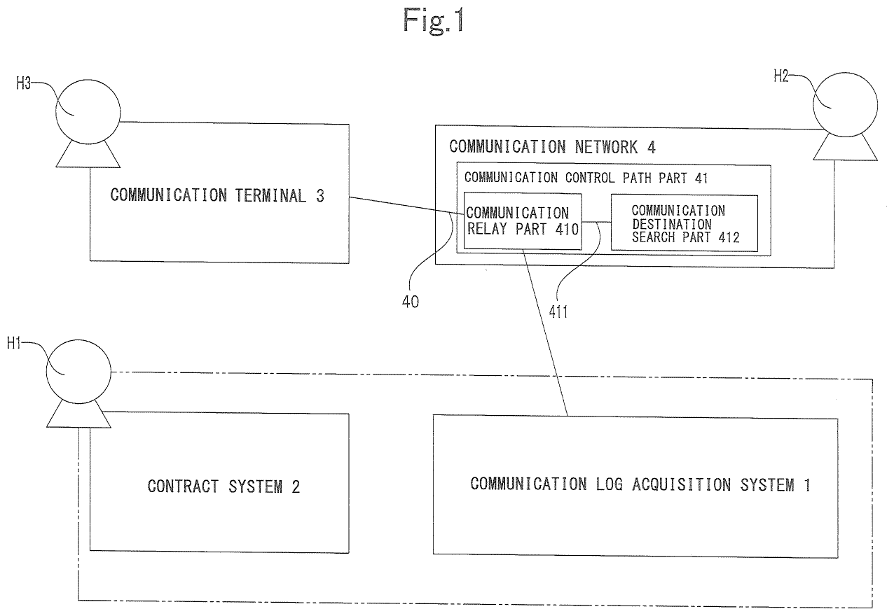

As shown in FIG. 1, a communication log acquisition system 1 is communicatively connected to, for example, a contract system 2 that allows an operation screen for contracting for a communication service to be displayed on a terminal (hereinafter referred to as the owned terminal) owned by a person who desires to contract for a communication service (hereinafter referred to as the contract applicant), a communication terminal 3 (hereinafter referred to as the contractor terminal 3) to which line identification information is set and which is communicatively connected to a communication line assigned to an individual who has contracted for the communication service (hereinafter referred to as the contractor), and a communication network 4 which includes a communication line to which the contractor terminal 3 can be connected.

The contract system 2 and the communication log acquisition system 1 are systems operated by a communication service provider (e.g., MVNO) H1, and the communication network 4 is a telecommunication facility operated by a communication carrier (e.g., MNO, MVNE, etc.) H2.

Moreover, a communication service is a service that allows a contractor to use a communication line. The communication service is, for example, a service that provides a contractor of a communication service with a SIM card, which is a storage medium that stores line identification information for identifying a communication line to be assigned (permitted to be used) to the contractor, or a service that provides a contractor of a communication service with a communication terminal (e.g., pocket Wi-Fi, etc.) equipped with an SIM, which is a storage medium that stores line identification information. The communication service provider can manage the line identification information in association with the communication line designated by the line identification information.

The line identification information is, for example, unique information assigned to the storage medium provided to the contractor, such as a calling number, FFCID, a serial number (serial number of the storage medium itself), a SIM card identifier, or a SIM identifier, and may be information capable of identifying the communication line to be used (designated communication line).

After the establishment of the contract for the communication service. the contractor can use the communication line identified by the line identification information through the contractor terminal, such as a communication terminal equipped with a SIM card or a communication terminal equipped with an eSIM.

A description will be given to the contract system 2, the contractor terminal 3, and a communication network 4, prior to the description of the communication log acquisition system 1.

The contract system 2 is a system through which a contract applicant enters into a contract for a communication service. As described above, the contract system 2 is configured to allow an operation screen for making a contract for a communication service to be displayed on a terminal owned by the contract applicant.

The contract system 2 can be configured to be able to making a contract for a communication service, and a service other than the communication service (e.g., a service using water, gas, or electricity). Hereinafter, the contract applicant who uses the contract system 2 to contract for a communication service will be referred to as a user

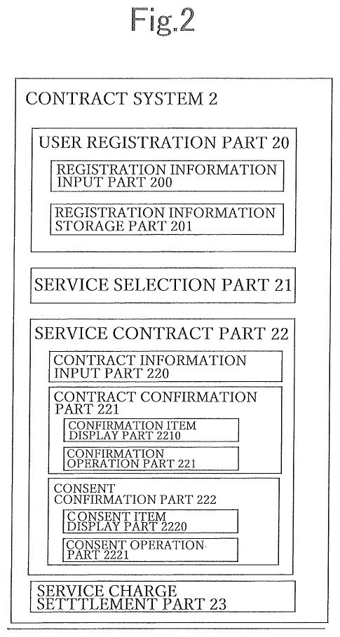

As shown in FIG. 2, the contract system 2 includes a user registration part 20 where the user registers his/her own information for starting to use the contract system 2, a service selection part 21 that selectably displays communication services to be provided to the user, a service contract part 22 that performs contract procedures for the communication service selected in the service selection part 21, and a service charge settlement part 23 that settles charges for the communication service for which the user has performed contract procedures using the service contract part 22.

The user registration part 20 is configured to allow the user to perform so-called user registration. The user registration part 20 includes a registration information input part 200 for inputting registration information required for user registration, and a registration information storage part 201 for storing the registration information.

The registration information refers to, for example, user's own personal information, login information used to log in to the contract system 2 (e.g., ID information used as a login ID, a password), and the like. The personal information includes, for example, the user's name, address, birth date, or the like.

The service selection part 21 is capable of allowing a plurality of communication services to be displayed on the owned terminal. The communication services displayed on the owned terminal by the service selection part 21 are categorized according to the form of the service. The form of the service is, for example, a service that provides a SIM card, a service that provides a communication terminal equipped with an eSIM, and the like.

Each of the plurality of communication services may include a plurality of plans with different service contents (e.g., charges, communication capacities, communication speeds, etc.).

The service contract part 22 includes a contract information input part 220 for inputting contract information required for a contract for the communication service, a contract confirmation part 221 for performing confirmation regarding the contract for the communication service, and a contract consent part 222 for obtaining consent to the acquisition of a communication log including the contractor's confidential information (e.g., call record, email address, number of SMS sent, connection history for data communication, charge history for data usage, data usage information, and other information known as confidentiality of communication).

The contract information input part 220 is configured to display an input form for inputting personal information of the user as contract information.

The contract information input part 220 of this embodiment is configured to automatically input personal information of the user into an input form. More specifically, the contract information input part 220 is configured to acquire the personal information of the user stored in the registration information storage part 201 and automatically input the personal information from the registration information storage part 201 into an input form.

The contract information input part 220 can allow the user to manually input information into the input form, or can allow the user to manually edit information input into the input form.

The confirmation regarding the contract for the communication service executed by the contract confirmation part 221 includes, for example, personal confirmation, and confirmation of important matter description.

The personal confirmation is confirmation that the person inputting the contract information into the contract information input part 220 is the contractor himself/herself.

The important matter description refers to the matter that need to be confirmed by the contractor when entering into a contract.

The contract confirmation part 221 of this embodiment includes a confirmation item display part 2210 that displays important confirmation items regarding the contract for the communication service, and a confirmation operation part 2211 that allows the user to perform a confirmation operation to indicate that the user has confirmed the important confirmation items regarding the contract for the communication service.

The confirmation operation part 2211 is configured to, for example, display a check box or button that the user clicks as a confirmation operation, or to display a form through which the user signs his/her name, etc. as a confirmation operation.

The contract consent part 222 is configured to start processing (operation) after the user performs a confirmation operation in the confirmation operation part 2211.

The contract consent part 222 in this embodiment includes a consent item display part 2220 that displays items for which consent is sought (in this embodiment, an explanation of the fact that a communication log including the confidentiality of communication will be acquired), and a consent operation part 2221 that allows the user to perform a consent operation indicating that the user has consented to the items for which consent is sought (hereinafter referred to as the consent items).

The consent operation part 2221 is configured to, for example, display a check box or button that the user clicks as a consent operation, or display a form through which the user signs as a consent operation. Furthermore, the consent operation part 2221 is configured to, upon receiving a consent operation from the user, output and store consent information indicating that the user has consented to the consent items.

The service charge settlement part 23 is configured to start processing (operation) after the consent operation part 2221 is operated by the user to give consent.

When the service charge settlement part 23 completes the settlement, a contract for the communication service is established, and line identification information is assigned to the contractor (the user who has established the contract).

When the contractor receives a storage medium in which the line identification information is stored or a communication terminal equipped with the storage medium in which the line identification information is stored, the contractor becomes able to use the communication line identified by the line identification information.

When the contractor is provided with a SIM card, which is a storage medium in which line identification information is set, the contractor inserts the SIM card into the communication terminal 3 such as a smartphone so that the line identification information is set (reflected) in the communication terminal 3, thereby enabling the contractor to use the communication line 40 identified by the line identification information (i.e., the communication line 40 designated in the line identification information) through the communication terminal 3 (i.e., the communication terminal 3 that has become the contractor terminal 3).

When the contractor is provided with the communication terminal 3 (e.g., pocket Wi-Fi, etc.) equipped with an eSIM, which is a storage medium in which line identification information is set, the contractor can use the communication line 40 identified by the line identification information from a different communication terminal (e.g., a smartphone, a tablet, a PC, etc.) via the communication terminal 3 by connecting the different communication terminal to this communication terminal (contractor terminal 3).

As shown in FIG. 1, the communication network 4 includes a communication line 40 (communication line used by the contractor terminal 3) identified by line identification information, and a communication control path part 41 that is a communication path connected to the communication line 40 and configured to control the communication of the contractor terminal 3.

The communication control path part includes a communication relay part 410 (so-called router) that relays communication between the contractor terminal 3 using the communication line 40 and an external network, and a communication destination search part 412 (so-called DNS server) connected to the communication relay part via a communication path 411.

The communication relay part 410 is configured to execute network address conversion for converting the IP address of the contractor terminal 3 and the IP address of the communication destination.

The communication relay part 410 is configured to generate an operation log (so-called NAT log) when network address conversion is executed. The operation log is a communication log generated on the communication path (in the communication control path part 41) connected to the communication line 40.

The operation log includes communication date and time information indicating the date and time when the contractor terminal 3 performed communication, line identification information set in the contractor terminal 3 that performed communication, a private IP address assigned to the contractor terminal 3 that performed communication, a global IP address converted from the private IP address, a global IP address of the communication destination, and line identification information.

This information contained in the operation log corresponds to the confidentiality of communication.

The private IP address of the contractor terminal 3 and the global IP address of the contractor terminal 3 in the operation log constitute a conversion log showing the result of converting the information for identifying the contractor terminal 3. The global IP address of the contractor terminal 3 and the global IP address of the communication destination in the operation log constitute a communication destination history log that shows the history of the communication destination of the contractor terminal 3. The line identification information in the operation log is an associated log that is associated with the conversion log or the communication destination history log.

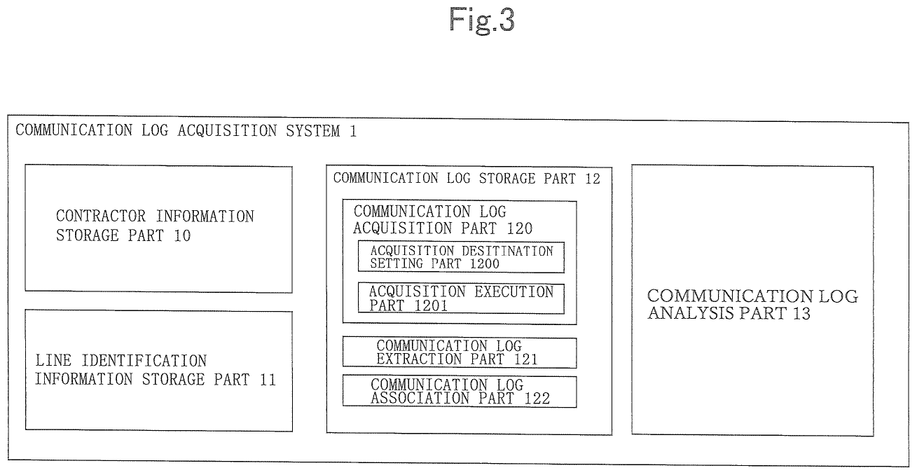

As shown in FIG. 3, the communication log acquisition system 1 includes a contractor information storage part 10 that stores contractor information regarding the contractor, a line identification information storage part 11 that stores line identification information assigned to the contractor, a communication log storage part 12 that stores a communication log of the contractor terminal 3, and a communication log analysis part 13 that analyzes the communication log stored by the communication log storage part 12.

The contractor information storage part 10 is configured to store, as contractor information, contractor identification information for identifying the contractor and consent information in association with each other.

The contractor information storage part 10 of this embodiment is configured to acquire personal information of the user stored by the registration information storage part 201, and generate contractor identification information based on the personal information. The contractor information storage part 10 can directly use the personal information as the contractor identification information, or can use new information associated with the personal information as the contractor identification information.

The contractor information storage part 10 may be configured to acquire the consent information output and stored by the consent operation part 2221.

The line identification information storage part 11 is configured to acquire contractor identification information that identifies a contractor of a communication service and line identification information assigned to the contractor of the communication service, and to store the line identification information in association with contractor information having contractor identification information of the same contractor as the contractor identified by the contractor identification information.

When a contractor is allowed to use a storage medium owned by a telecommunication carrier, the line identification information storage part 11 may be configured to acquire line identification information from the telecommunication carrier, and when a contractor is allowed to use a storage medium owned by a communication service provider, the line identification information storage part 11 may be configured to acquire line identification information managed by the communication service provider.

The communication log storage part 12 includes a communication log acquisition part 120 that acquires the communication log of the contractor terminal 3, a communication log extraction part 121 that derives communication date and time information, caller number information, caller information, and destination information based on the communication log acquired by the communication log acquisition part 120 to generate extracted information, and a communication log association part 122 that stores the extracted information derived by the communication log extraction part 121 in a state associated with the contractor information.

The communication log acquisition part 120 is configured to acquire a communication log from the communication line 40 used by the communication terminal 3 (contractor terminal 3) in which the line identification information associated with the consent information is set, and to store the communication log in association with the contractor information of the contractor.

The communication log acquisition part 120 of this embodiment includes an acquisition destination setting part 1200 that sets an acquisition destination of the communication log, and an acquisition execution part 1201 that acquires the communication log from the acquisition destination set by the acquisition destination setting part 1200

The acquisition destination setting part 1200 is configured to set the acquisition destination of the communication log on a communication path (communication control path part 41) connected to the communication line 40 (communication line 40 used for communication by the calling number) identified by line identification information associated with the contractor information including the consent information.

When the acquisition destination setting part 1200 sets the communication relay part 410 as the acquisition destination of the communication log, the acquisition execution part 1201 acquires the operation log (NAT log) of the communication relay part 410 when the contractor terminal 3 performs communication.

The communication log extraction part 121 is configured to extract communication date and time information, caller number information, caller information, and communication destination information from the operation log, and to generate extracted information as extracted information.

The communication log extraction part 121 may be configured to extract the communication date and time information, the caller number information, the caller information, and the communication destination information included in the communication log and directly use them as extracted information, or it may be configured to extract the communication date and time information, the caller number information, the caller information, and the communication destination information and use them as extracted information in a converted state (e.g., in a state in which the global IP address of the communication destination is converted into a domain name) The communication log association part 122 is configured to search for contractor information associated with calling number information indicating the same calling number as the calling number indicated by the calling number information derived by the communication log extraction part 121, and to store the extracted information derived by the communication log extraction part 121 in a state associated with the contractor information.

The contractor information, the calling number information, the communication log, and the extracted information may be stored by being stored in a storage device provided in the communication log acquisition system 1, or they may be stored by being stored in an external storage device that is communicatively connected to the communication log acquisition system 1 via wireless or wired connection. The communication log acquisition system 1 and the external storage device may be configured to communicate directly with each other, or may be configured to communicate with each other via a network.

The communication log analysis part 13 may be configure to be able to analyze trends such as the frequency of communication to a specified communication destination and the communication time with a specified communication destination based on, for example, the contractor information or the extracted information associated with the contractor information.

The configuration of the communication log acquisition system 1 according to this embodiment is as described above. Next, the operation of the communication log acquisition system 1 will be described.

In this embodiment, the operation of the communication log acquisition system 1 is explained by taking, for example, the flow of making a contract for a communication service using the contract system 2 and starting to acquire a communication log using the communication log acquisition system 1 subsequent to the establishment of the contract for the communication service.

The flow of contracting for a communication service using the contract system 2 will be described.

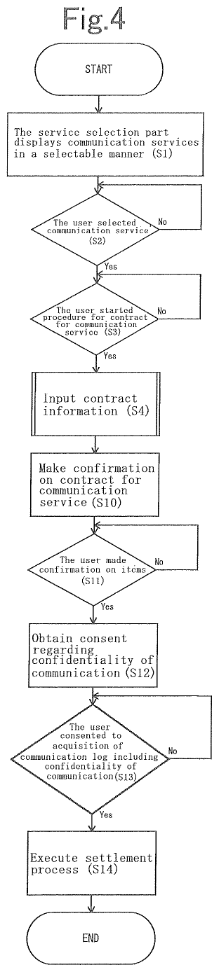

As shown in FIG. 4, the contract system 2 displays communication services which the service selection part 21 provides to the user in a selectable manner (S1).

When the user selects a communication service (Yes in S2) and starts the procedure for making a contract for the communication service (Yes in S3), contract information is input in the contract information input part 220 (S4).

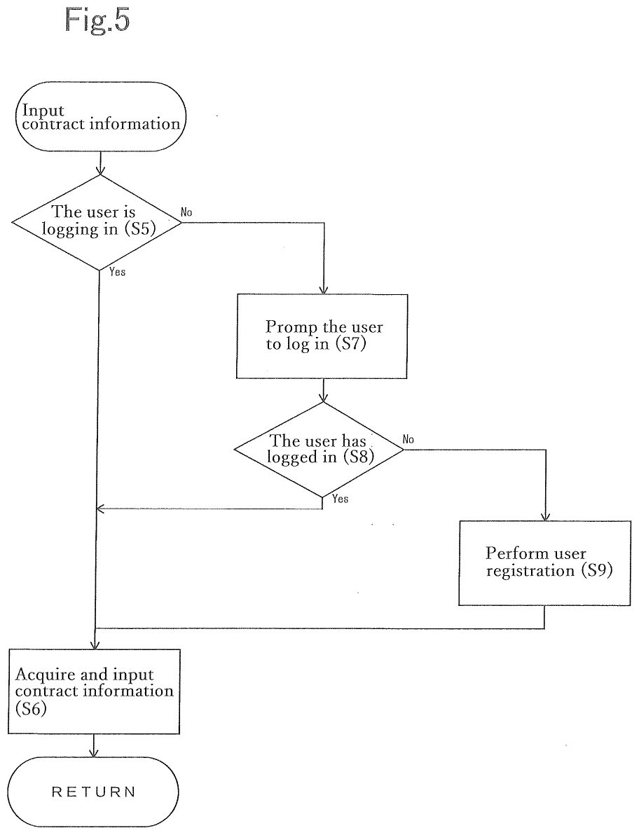

As shown in FIG. 5, in the state where a user who has already registered is logged in to the contract system 2 (Yes in S5), the contract information input part 220 acquires the user's personal information stored in the registration information storage part 201 and inputs the personal information into the input form (S6).

If the user is not logged in (No in S5), a process for prompting the user to log in is executed (S7).

Then, when the user logs in (Yes in S8), the contract information input part 220 acquires the personal information of the user stored in the registration information storage part 201, and inputs the personal information into the input form (S6).

On the other hand, if user registration has not been performed and the user cannot log in (No in S8), user registration is performed by the user registration part 20 (S9), and then the personal information that was entered into the registration information input part 200 during user registration by the user registration part 20 and then the personal information stored by the registration information storage part 201 is acquired by the contract information input part 220 and input into the input form (S6).

In this way, the contract information input part 220 of this embodiment is configured to acquire the personal information stored by the registration information storage part 201 during user registration in the contract system 2, and automatically input this personal information into the input form.

Next, as shown in FIG. 4, the contract confirmation part 221 confirms the contract for the communication service (S10).

In the confirmation of the contract for the communication service, the confirmation item display part 2210 displays the confirmation items, and the process is completed when the user performs a confirmation operation in the confirmation operation part 2211 (Yes in S11).

As described above, the operational state is not changed while the confirmation operation part 2211 is not being operated by the user for confirmation (No in S11), and if it is determined that the user will not perform a confirmation operation, the processing may be terminated.

When confirmation regarding the contract for the communication service is completed (Yes in S11), the contract consent part 222 obtains consent regarding the contract for the communication service (consent to the acquisition of a communication log including confidentiality of communication) (S12).

When the contract consent part 222 obtains consent regarding the contract for the communication service, the consent item display part 2220 displays the consent items, and consent is completed when the user performs a consent operation in the consent operation part 2221 (Yes in S13). At this time, the consent operation part 2221 outputs and stores the consent information.

As described above, the consent operation part 2221 does not change the operational state when the user is not performing the consent operation (No in S13), and if it is determined that the user will not perform the consent operation, the processing may be terminated.

If consent is obtained regarding the contract for the communication service (Yes in S13), the service charge settlement part 23 executes the settlement process (S14).

When the settlement is completed by the service settlement part 23, the contract for the communication service is completed (established). A contractor (a user who has established a contract) is provided with a storage medium in which line identification information is stored, or a communication terminal 3 equipped with the storage medium in which line identification information is stored.

Thereby, the contractor becomes able to use the communication line 40 identified by the line identification information from the communication terminal 3, and the communication log acquisition system 1 becomes able to acquire the communication log of the contractor terminal 3.

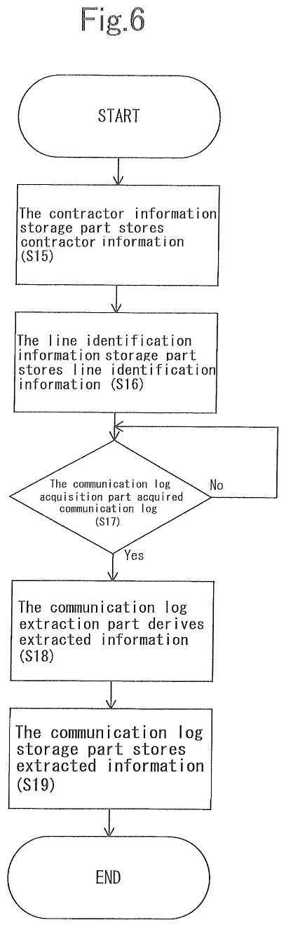

As shown in FIG. 6, in the communication log acquisition system 1, the contractor information storage part 10 stores contractor information (S15), and the line identification information storage part 11 stores caller number information (S16).

Then, when the communication log acquisition part 120 acquires the operation log of the communication relay part 410 as a communication log (Yes in S17), the communication log extraction part 121 creates extracted information based on the communication log acquired by the communication log acquisition part 120 (S18), and the communication log association part 122 stores the extracted information in a state associated with the contractor information (S19).

Although not shown in FIG. 6, when analyzing the communication log in the communication log analysis part 13, the communication log analysis part 13 may acquire extracted information, contractor information or the like at any time and perform analysis based on the acquired information.

As described above, in the communication log acquisition system 1 of this embodiment, the contractor information storage part 10 stores the line identification information and the consent information in association with each other, the line identification information assigned to the contractor of the communication service, the consent information indicating that the contractor of the communication service has consented to the acquisition of the confidentiality of communication of the communication terminal 3 in which the line identification information is set. The communication log acquisition part 120 is configured to acquire a communication log from a communication path connected to the communication line 40 used by the communication terminal 3 in which the line identification information associated with the consent information is set.

Therefore, the communication log acquisition system 1 of this embodiment is configured to acquire a communication log from a contractor who has consented to the acquisition of the confidentiality of communication. Thereby, it is possible to achieve the excellent effect of properly acquiring a communication log including the confidentiality of communication.

It should be noted that the communication log acquisition system 1 according to the present invention is not limited to the above embodiment, and various modifications can be made without departing from the spirit and scope of the present invention.

The contract system 2 and the communication log acquisition system 1 may be integrated into a communication service providing system.

Although not specifically mentioned in the above embodiment, the contract system 2 is a system that is used by a user through a terminal such as a personal computer.

Although not specifically mentioned in the above embodiment, in the contract system 2, user registration may be performed by the user registration part 20 before the service selection part 21 selectably displays communication services.

The contract system 2 of the above embodiment is configured such that the contract information input part 220 executes a process of acquiring and inputting personal information, then the contract confirmation part 221 executes a process of confirming the contract for the communication service, and then the contract consent part 222 executes a process of obtaining consent regarding the contract for the communication service. However, the order in which these three processes are executed is not particularly essential, and at least two of these three processes may be executed simultaneously.

In addition, the settlement processing of the service settlement part 23 may be configured to be executed after all of the following processes have been completed: the process of acquiring and inputting personal information by the contract information input part 220, the process of confirming the contract for the communication service by the contract confirmation part 221, and the process of obtaining the consent to the contract for the communication service by the contract consent part 222.

Although the communication log acquisition part 120 in the above embodiment is configured to acquire a communication log from the communication relay part 410, the present invention is not limited to this configuration. For example, the communication log acquisition part 120 may acquire a communication log from a telecommunication facility other than the communication relay part 410 constituting the communication control path part 41, such as the communication destination search part 412 or the communication path 411.

Further, the communication log acquisition part 120 in the above embodiment acquires the operation log (NAT log) of the communication relay part 410 as the communication log, but is not limited to this configuration. The communication log acquisition part 120 may be configured to acquire a different type of a communication log from the NAT log, such as a DNS log, as the communication log. The communication log acquisition part 120 may be configured to acquire a plurality of different types of communication logs, and may be configured to acquire, for example, both a NAT log and a DNS log.

Further, in the above embodiment, the communication log acquisition part 120 is configured to acquire the conversion log, the communication history log, and the related log, but is not limited to this configuration. The communication log acquisition part 120 may be configured to acquire only the communication history log, for example.

In this case, the communication log storage part 12, for example, may be configured to allow the communication log extraction part 121 to refer to the line identification information, the private IP address, and the global IP address that have already been stored in a mutually associated state, and derive the line identification information from the global IP address that constitutes the communication history log acquired by the communication log acquisition part 120.

The communication log acquisition part 120 may be configured to acquire a communication history log from the communication relay part 410, or may be configured to acquire a communication history log from the communication relay part 410, or may be configured to acquire a communication history log from a telecommunication facility other than the communication relay part 410 that constitutes the communication control path part 41, such as the communication destination search part 412 or the communication path 411.

The contract system 2 in the above embodiment is configured such that only users who consented to have their communication logs including the confidentiality of their communications acquired can enter into a contract for a communication service, but the contract system 2 is not limited to this configuration. The contract system 2 may be configured such that, for example, even users who have not consented to the acquisition of their communication logs including the confidentiality of their communications can enter into a contract for a communication service.

In this case, the consent operation part 2221 is configured to output and store non-consent information indicating that a user has not consented to the acquisition of the communication log including the confidentiality of communication, and the contractor information storage part 10 is configured to acquire the non-consent information output and stored by the consent operation part 2221.

In this way, it is possible to ascertain the contractor's consent status to the acquisition of a communication log including the confidentiality of communication by referring to the contractor information associated with the line identification information, and checking whether the information included in the contractor information is consent information or non-consent information.

In the case where the contract system 2 is configured to allow a user who has not consented to the acquisition of the communication log including the confidentiality of communication to enter into a contract for a communication service, the service selection part 21 may display, among the communication services, selectable plans, specifically one plan (a regular plan) for users who have not consented to the acquisition of their communication logs including the confidentiality of their communications and another plan (a courtesy plan) for users who have consented to the acquisition of their communication including the confidentiality of their communications.

The acquisition destination setting part 1200 is configured to set, as the acquisition destination of the communication log, the communication path including the communication line 40 identified by the line identification information associated with the contractor information including the consent information. Therefore, for example, if separate communication lines are respectively given to a communication line for communication using line identification information assigned to a contractor who has consented to the acquisition of the communication log including the confidentiality of communication, and a communication line for communication using line identification information assigned to a contractor who has not consented to the acquisition of the communication log including the confidentiality of communication, it is possible to acquire only the communication log of the contractor who has consented to the acquisition of the communication log including the confidentiality of communication.

Although not specifically mentioned in the above embodiment, the communication log acquisition part 120 may be configured to acquire, as a communication log, an operation log generated by the communication destination searching part 412 (so-called DNS server).

Although not specifically mentioned in the above embodiment, the communication log acquisition part 120 may acquire the communication log directly from the communication control path part 41, or may be configured to acquire the communication log stored outside the communication control path part 41.

The present disclosure includes the following matters.

(1) A communication log acquisition system includes: a contractor information storage part that stores line identification information and consent information in a state associated with each other, the line identification information assigned to a contractor of a communication service, the consent information indicating that the contractor of the communication service has consented to acquisition of confidentiality of communication of a communication terminal to which the line identification information is set; and a communication log acquisition part that acquires a communication log from a communication path that is connected to a communication line used by a communication terminal to which the line identification information associated with the consent information is set.

In the communication log acquisition system of (1), when a communication terminal in which line identification information is set performs communication, the line identification information set in the communication terminal remains in the communication log.

The contractor information storage part stores the line identification information and the consent information in association with each other, the line identification information assigned to the contractor of the communication service, the consent information indicating that the contractor of the communication service has consented to the acquisition of the confidentiality of communication of the communication terminal in which the line identification information is set. The communication log acquisition part is configured to acquire a communication log from a communication path connected to the communication line used by the communication terminal in which the line identification information associated with the consent information is set.

Therefore, the communication log acquisition system is configured to acquire a communication log from a contractor (consenter) who has consented to the acquisition of the confidentiality of communication. Thereby, it is possible to properly acquire a communication log including the confidentiality of communication.

More specifically, according to the communication log acquisition system configured as described above, information referred to as confidentiality of communication, such as call records, email addresses, number of SMS sent, connection history for data communication, charge history for data usage, data usage information, or the like, which is information that is not permitted to be acquired without the consent of the person (the person himself/herself) associated with the confidentiality of communication, can be appropriately acquired only from those who have given consent.

Furthermore, for example, by configuring an advertising system that includes a communication log acquisition system and a distribution system that distributes advertisements selected based on communication logs including the confidentiality of communication acquired by the communication log acquisition system to a user's communication terminal, it becomes possible to distribute advertisements using both communication logs that do not include the confidentiality of communication and communication logs that include the confidentiality of communication, making it possible to deliver advertisements to users that are more suited to their needs.

(2) A communication log acquisition system used together with a contract system through which a contractor makes a contract for a communication service,
the contract system including:
a contract operation part for allowing a person who wishes to make a contract for the communication service to perform a contract operation for making a contract for the communication service; and
a contract information creation part that creates contract information that is information regarding the contractor,
the contract information including:
contractor identification information for identifying a communication terminal used by the contractor;
line identification information that can identify a communication line assigned to the contractor; and
consent information indicating whether the contractor has consented to acquisition of a communication log that includes confidential information of the contractor among communication logs generated when the contractor uses the communication line indicated by the line identification information, the consent information being associated with the line identification information;
the communication log acquisition system further including:
a contractor information storage part that acquires and stores the plurality of contract information pieces; and
a communication log acquisition part that acquires a communication log from the communication line,
the communication log acquisition part being configured to select, from among the plurality of contract information pieces, information in which the contractor consents to acquisition of a communication log including confidential information of the contractor is set in the consent information; and
to acquire the communication log of the communication terminal identified by the contractor identification information from the communication line specified based on the line identification information of the selected contract information.

### REFERENCE SIGNS LIST

1: Communication log acquisition system
2: Contract system
3: Communication terminal
4: Communication network
10: Contractor information storage part
11: Line identification information storage part
12: Communication log storage part
13: Communication log analysis part
20: User registration part
21: Service selection part
22: Service contract part
23: Service charge settlement part
40: Communication line
41: Communication control path part
120: Communication log acquisition part
121: Communication log extraction part
122: Communication log association part
200: Registration information input part
201: Registration information storage part
220: Contract information input part
221: Contract confirmation part
222: Contract consent part
410: Communication relay part
411: Communication path
412: Communication destination search part
1200: Acquisition destination setting part
1201: Acquisition execution part
2210: Confirmation item display part
2211: Confirmation operation part
2220: Consent item display part
2221: Consent operation part

1. A communication log acquisition system comprising:
a contractor information storage part that stores line identification information and consent information in a state associated with each other, the line identification information assigned to a contractor of a communication service, the consent information indicating that the contractor of the communication service has consented to acquisition of confidentiality of communication of a communication terminal to which the line identification information is set; and
a communication log acquisition part that acquires a communication log from a communication path that is connected to a communication line used by a communication terminal to which the line identification information associated with the consent information is set.
